(19) United States
(12) Patent Application Publication
(10) Pub. No.: US 2010/0316001 A1
(43) Pub. Date: Dec. 16, 2010

(54) Method of Transmitting Synchronized Speech and Video

(75) Inventors: Daniel Enstrom, Gammelstad (SE); Hans Hannu, Lulea (SE); Per Synnergren, Lulea (SE)

Correspondence Address: COATS & BENNETT, PLLC, 1400 Crescent Green, Suite 300, Cary, NC, 27518, US

(73) Assignee: TELEFONAKTIEBOLAGET LM ERICSSON (PUBL), Stockholm (SE)

(21) Appl. No.: 12/866,037

(22) PCT Filed: Jun. 24, 2008
(86) PCT No.: PCT/SE08/50753

§ 371 Date: Aug. 4, 2010

Related U.S. Application Data
(60) Provisional application No. 61/026,226, filed on Feb. 5, 2008.

(51) Int. Cl. H04W 56/00

(52) U.S. Cl. 370/328

(57) ABSTRACT

In a method and mobile station for transmitting speech data over a packet data connection and video-data over a packet switched connection information about the rendering and capturing clocks for both a Circuit switched (CS) speech connection and a Packet Switched (PS) video connection are determined by a transmitter. The information is transmitted to a receiver and the receiver uses the information to enable synchronization between the speech connection and the video connection.

### TECHNICAL FIELD

The present invention relates to a method and a device for transmitting synchronized speech and video.

### BACKGROUND

Cellular Circuit Switched (CS) telephony was the first service introduced in the first generation of mobile networks. Since then CS telephony has become the largest service in the world.

Today, it is the second generation (2G) Global System for Mobile Communication (GSM) network that dominates the world in terms of installed base. The third generation (3G) networks are slowly increasing in volume, but the early predictions that the 3G networks should start to replace the 2G networks already a few years after introduction and become dominating in sales has proven to be wrong.

There are many reasons for this, mostly related to the costs of the different systems and terminals. But another reason may be that the early 3G networks was unable to provide the end user the performance they needed for IP services like e.g. web surfing and peer-to-peer IP traffic. Another reason may also be the significantly worse battery lifetime of a 3G phone compared to a 2G phone. Some 3G users actually turn of the 3G access, in favor for the 2G access, to save battery.

Later 3G network releases includes High Speed Packet Access (HSPA), HSPA enable the end users to have bit rates that can be compared to bit the rates provided by fixed broadband transport networks like Digital Subscriber Line (DSL). Since the introduction of HSPA, a rapid increase of data traffic has occurred in the 3G networks. This traffic increase is mostly driven by lap-top usage when the 3G telephone acts as a modem. In this case battery consumption is of less interest since the lap-top powers the phone.

After HSPA was introduced, battery consumption became a focus area in the standardization. This lead to the opening of a working item in the 3rd Generation Partnership Project (3GPP) called Continuous Packet Connectivity (CPC). This working item aimed to introduce a mode of operation where the phone could be in an active state but still have reasonably low battery consumption. Such state could for instance give the end-user a low response time when clicking a link in a web page but still give a long stand by time.

The features developed in the CPC working item were successfully included in the 3GPP Release 7 specifications. But, the gain of CPC could only be utilized when running HSPA. This means that battery lifetime increase cannot be achieved for users using the CS telephony service.

In order to be able to increase the talk time of CS telephony another working item has been open that aims to make CS telephony over HSPA possible.

From a high-level perspective a CS over HSPA solution can be depicted as in FIG. 1. An originating mobile station connects via HSPA to the base station NodeB. The base station is connected to a Radio Network Controller (RNC) comprising a jitter buffer. The RNC is via a Mobile Switching Center (MSC)/Media Gateway (MGW) connected to an RNC of the terminating mobile station. The terminating mobile station is connected to its RNC via a local base station (NodeB). The mobile station on the terminating side also comprises a jitter buffer.

In the scenario depicted in FIG. 1, the air interface is using Wideband Code Division Multiple Access (WCDMA) HSPA, which result in that:

The uplink is High Speed Uplink Packet Access (HSUPA) running 2 ms Transmission Time Interval TTI and with Dedicated Physical Control Channel (DPCCH) gating.

The downlink is High Speed Downlink Packet Access (HSDPA) and can utilize Fractional Dedicated Physical Channel (F-DPCH) gating and Shared Control Channel for HS-DSCH (HS-SCCH) less operation, where the abbreviation HS-DSCH stands for High Speed Downlink Shared Channel.

Both uplink and downlink uses Hybrid Automatic Repeat Request (H-ARQ) to enable fast retransmissions of damaged voice packets.

The use of fast retransmissions for robustness, and HSDPA scheduling, requires a jitter buffer to cancel the delay variations that can occur due to the H-ARQ retransmissions, and scheduling delay variations. Two jitter buffers are needed, one at the originating RNC and one in the terminating terminal. The jitter buffers use a time stamp that is created by the originating terminal or the terminating RNC to de-jitter the packets.

The timestamp will be included in the Packet Data Convergence Protocol (PDCP) header of a special PDCP packet type. A PDCP header is depicted in FIG. 2.

There is a constant strive to enhance telephony services. Hence there exists a need to improve the services provided in a Circuit Switched (CS) connection over a packet data channel such as a High Speed Packet Access (HSPA) channel.

### SUMMARY

It is an object of the present invention to provide an improved service for users using a Circuit Switched (CS) connection over a packet data channel such as a High Speed Packet Access (HSPA) channel. In particular it is an object of the present invention to provide a synchronization mechanism whereby a Circuit Switched (CS) connection over a packet data channel such as a High Speed Packet Access (HSPA) channel can be synchronized with a packet switched (PS) connection.

This object and others are obtained by the method and device as set out in the appended claims. Thus information about the rendering and capturing clocks for both a Circuit switched (CS) speech connection and a Packet Switched (PS) video connection are determined by a transmitter. The information is transmitted to a receiver and the receiver uses the information to enable synchronization between the speech connection and the video connection.

The invention also extends to a transmitter and a receiver adapted to transmit and receive speech data transmitted over a circuit switched connection and video data transmitted over a packet switched connection in accordance with the above.

Using the method, transmitter and receiver in accordance with the invention will allow a transmitter to generate a PS video data stream that can be synchronized with a parallel CS speech data stream by a receiver thereby enabling synchronization of CS speech with PS video. This will significantly enhance the media quality of a video session. The invention can for example be used to for a Circuit switched HSPA connection or any other type of Circuit switched connection such as Long Time Evolution (LTE) Wideband Local Area Network (WLAN) or whatever Circuit switched connection that needs to be synchronized with a Packet switched connection.

### BRIEF DESCRIPTION OF THE DRAWINGS

The present invention will now be described in more detail by way of non-limiting examples and with reference to the accompanying drawings, in which:

FIG. 1 is a general view of a system used for packeized voice communication,

FIG. 2 is a view of a Packet Data Convergence Protocol (PDCP) header,

FIG. 3 is a flow chart illustrating steps performed when transmitting in-band clock information,

FIG. 4 is a flow chart illustrating steps performed when receiving in-band clock information,

FIG. 5 is a flow chart illustrating steps performed when transmitting out of band clock information,

FIG. 6 is a flow chart illustrating steps performed when receiving out of band clock information, and

FIG. 7 is a general view of a transmitter transmitting speech and video data to a receiver.

### DETAILED DESCRIPTION

In accordance with the present invention an existing mechanism is used to convey enough information about the rendering and capturing clocks for both a Circuit switched (CS) speech connection and a Packet Switched (PS) video connection to enable lip synchronization between the speech connection and the video connection.

In order to enable the receiver to synchronize speech and video data the transmitter is adapted to provide timing information about capturing time for each media to be synchronized and transmitting the timing information to the receiver. In addition the transmitter is adapted to transmit Sender wall clock information to the receiver to give the receiver the possibility to relate the different media flows to each other time wise.

For pure PS transport, where both media flows are transmitted using Real Time Transfer Protocol (RTP)/UDP/IP, both of the above requirements are fulfilled. Each RTP packet for each media flow includes a relative time stamp (TS) which can be related to clock time using information from the session set-up. E.g. for AMR audio, the RTP TS is denoted in samples where each 160 clock tick increase equals 160 samples which in turn equals 20 msec. in other words, the clock controlling the RTP TS for AMR audio runs at 8 kHz. For video, the clock runs normally at 90 kHz. Now, since the clocks of the respective flow is completely independent, there is a need to convey the wall clock time upon which each media flow clock rate is based from the sender to the receiver. If not, the receiver can only detect the relative timing between the media flows, not the absolute timing. This wall clock time is conveyed using Real Time Transport Control Protocol (RTCP) sender reports (SR). In each sender report both the wall clock time and the RTP TS is sent, both set at the instance the report was created. Hence, a connection between the RTP TS and the wall clock time of the sender is established.

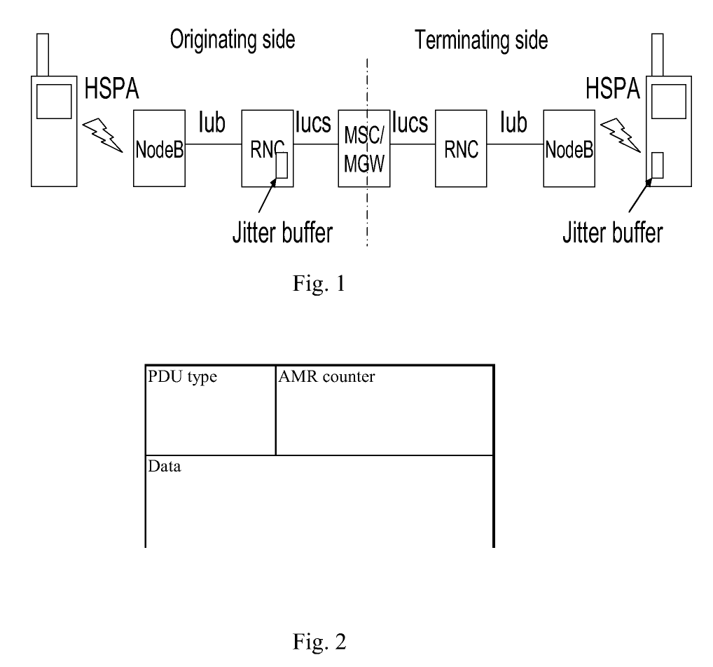

As is described above, the PS video clock info is already available when using PS video and CS speech. Further the relative timing of the AMR frames is also available since the receiver knows that the sender will produce one AMR frame every 20 msec and the receiver can control sequence numbering using the AMR counter field in the PDCP header as is shown in FIG. 2.

In order to provide synchronization between CS speech and PS video the wall clock time for the CS flow and the connection to a particular received AMR frame which was captured at the particular time when the wall clock time was sampled needs to be provided.

In accordance with one embodiment, the PS video connection utilizes RTCP SR. Also the same clock, which controls the information in the sending UE RTCP SR, is also available for the CS speech application in the sending User Equipment (UE). Some exemplary embodiments will now be described in more detail below.

In accordance with one embodiment proper wall clock transmission for the CS media flow is ensured by including wall clock information in the encoded media stream. This can be implemented in different ways. In accordance with one exemplary implementation in-band clock information is transmitted. When in-band clock information is transmitted Dual Tone Multi Frequency (DTMF) tones can be used to encode the wall clock time. Assuming that the wall clock encoding can be done as in RTCP SR, 4 bytes are typically needed to convey the information.

DTMF, used as standardized in 3GPP, specifies that each tone needs to be at least 70 (+/−5) msec. Each DTMF tone, or DTMF event, can convey 4 bits giving at least 8 events to transmit. Further, there needs to be at least 65 msec silence between each event giving a total minimum DTMF transmission time of:

8*70+7*65=1015 msec

A shorter wall clock format can also be used for example by leaving out date and year as signaled in the RTCP SR.

A synchronization skew of 1 second typically cannot be allowed for synchronized media so the transmitted wall clock time can be adjusted to comprise the transmission time of the DTMF message. Hence, three different algorithms are typically required when transmitting in-band clock information using Dual Tone Multi Frequency (DTMF) tones to encode the wall clock time.

Transmission of adjusted wall clock time using DTMF tones

Receiver coordination and DTMF signaling context detection (i.e. the receiver knows using the SIP/SDP signaling for the PS session that DTMF tones received just when setting up the video component contains wall clock time) resulting in DTMF decoding of wall clock time.

Receiver speech frame counter (so that the received PDCP frame counter from the RLC layer can be related to the wall clock time).

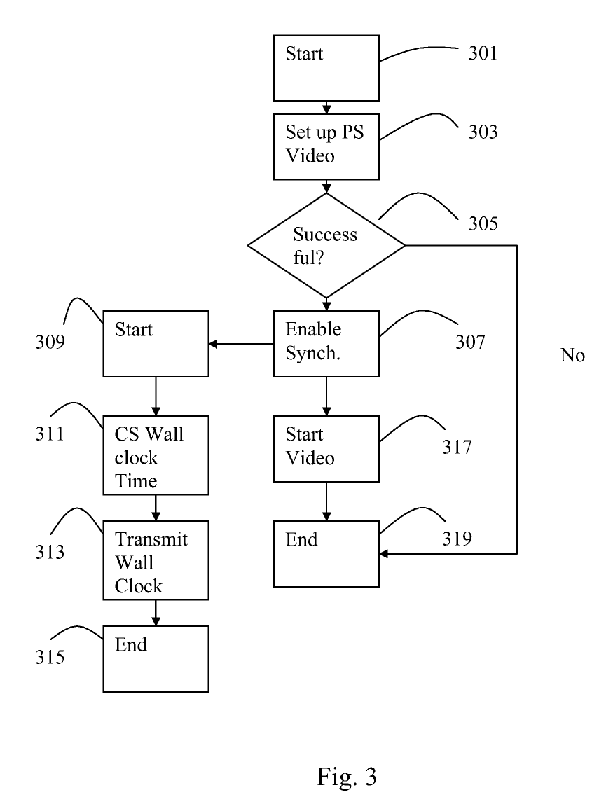

In FIG. 3 a flowchart illustrating steps performed when providing in-band clock information for synchronization of CS speech with PS video at the transmitter side in accordance with an exemplary embodiment of the invention. First in a step 301 the transmission is initiated. Next in a step 303 a session for PS video is set up for example using SIP/SDP signaling. Thereupon, in a step 305 it is checked if the set up is successful. If the set-up is not successful the procedure continues to a step 319. If the set up is successful the procedure continues to a step 307. In step 307 the transmitter initiates synchronization of the PS video stream with CS Speech. This can preferably be performed by starting the video transmission in a step 317 and the video initiation is then ended in a step 319. In parallel with the start of the video transmission a transmission of adjusted wall clock time using DTMF tones is initiated in a step 309.

When transmission of adjusted wall clock time using DTMF tones in a step 309 has been initiated, the procedure continues to a step 311. In step 311 the CS wall clock time is captured and adjusted for transmission delay. Next in a step 313 the wall clock time is transmitted in the CS speech flow using DTMF signaling. The transmission of Wall clock time is then completed in a step 315.

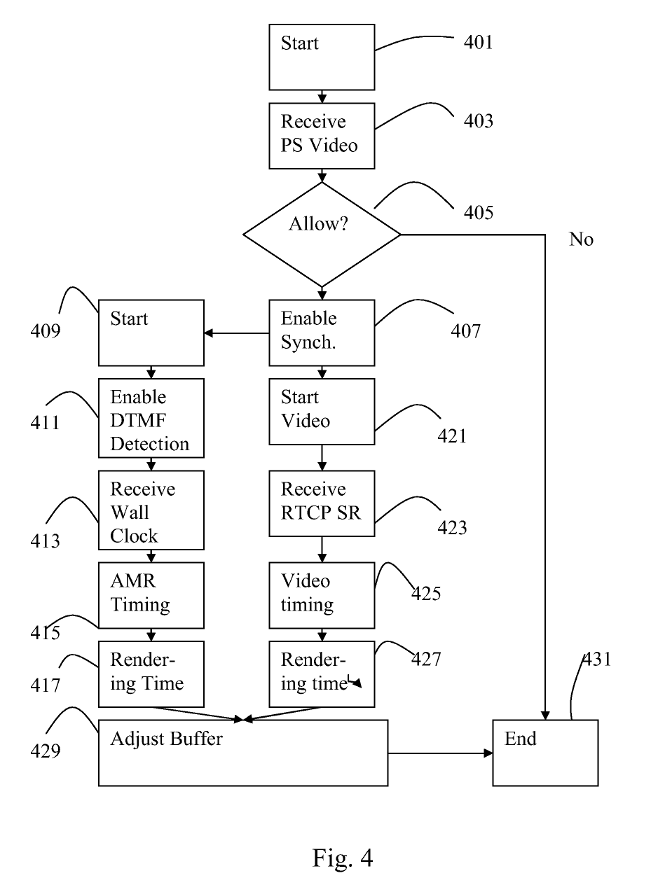

In FIG. 4 a flowchart illustrating steps performed when providing in-band clock information for synchronization of CS speech with PS video at the receiver side in accordance with an exemplary embodiment of the invention. First in a step 401 the reception is initiated. Next in a step 403 an invitation for a PS session is received. Thereupon in a step 405 the receiver decides if the Video session is to be allowed. If the video session is rejected the procedure ends in a step 431. If the video session is accepted the procedure continues to a step 407. In step 407 enabling of synchronization with CS speech is initiated. In a step 409 CS speech synchronization is started. In a step 411 DTMF wall clock detection in the speech decoder is enabled. Next, in a step 413 DTMF wall clock time is received and decoded. Thereupon in a step 415, the absolute timing of AMR frame number is determined: Next in a step 417, the rendering time of a received speech frame is determined. The procedure then continues to a step 429.

The receiver also receives PS video, which can take place in parallel with CS speech synchronization. The receiver hence also starts receiving video in a step 421. The first RTCP SR report is then received in a step 423. Next in a step 425, the absolute timing of video frames is determined. Next in a step 427, the rendering time of a received video frame with a particular RTP TS number is determined.

Thereupon in a step 429, the rendering time for a received CS speech AMR frame number and a received RTP TS PS video frame are determined and the buffer is adjusted accordingly and the procedure ends in a step 431.

As is described above in conjunction with FIGS. 3 and 4, a mapping between a particular speech frame, either using a speech frame number (as forwarded from the RLC layer) or using the AMR counter timing information from the PDCP header, and a terminal unique capture time of the particular media frame is obtained. Using this information, a synchronized rendering is enabled for a CS speech frame and a PS video frame.

It should be noted that this mechanism works reliably also without transcoding free operation. If end-to-end transport of the encoded media is possible other means are available to convey the CS wall clock time. In accordance with one embodiment so-called homing frames, or other unique synthesized bit-patterns in the encoded speech frame, indicating a reset of the wall clock to zero when the first video frame was captured can be used. If a reset of the wall clock to zero is used, the wall clock time will be transmitted as “zero”, i.e. implicitly. However, since only the connection to the capturing time of the respective media and the RTP TS and the AMR speech frame number is needed, the actual number used to indicate wall clock time need not be used as long as it is shared among all media components in the session.

In an alternative embodiment of conveying the CS wall clock information from the transmitter to a receiver a feedback message for the PS video. In one embodiment standard RTCP SR can be used. The feedback message can have clearly defined fields with a dedicated purpose. The RTP profile used for audio and video transport also holds the possibility to introduce so-called APP messages, i.e. APPlication Specific Feedback Messages where the content can be tailored by the application developer, or messages that include application specific information. These APP messages can be appended to the original RTCP SR or Receiver Reports (RR) and hence share the same transport mechanism.

Using the APP message, the CS wall clock information can be sent in several different ways. One way is to transmit the AMR speech frame number captured at the same RTP TS as written in the RTCP SR hence giving the information needed to establish a relation between a particular video frame, the wall clock time when it was sampled as sent in the RTCP SR and the corresponding AMR speech frame number. Other kinds of uniquely identifying patterns such as a copy of the speech frame encoded at the same capturing time as the first video frame and use pattern recognition schemes in the receiver to establish the frame number/wall clock relation needed for synchronization can also be used.

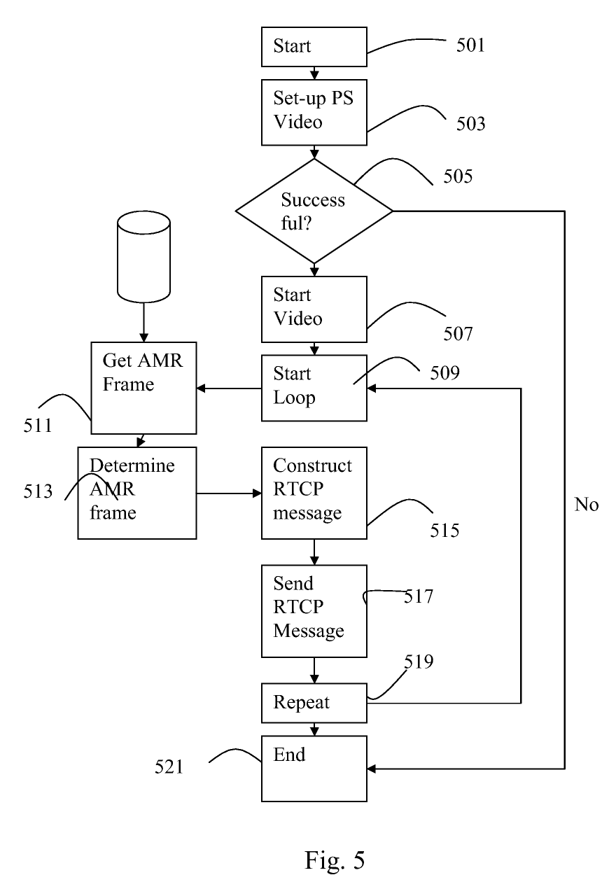

In FIG. 5 an exemplary flow chart of procedural steps performed in a transmitter when providing synchronized CS speech with PS video using out of band synchronization is shown. First the transmission is initiated in a step 501. Next, in a step 503 a session for PS video is set up for example using SIP/SDP signaling. Thereupon, in a step 505 it is checked if the set up is successful. If the set-up is not successful the procedure continues to a step 521. If the set up is successful the procedure continues to a step 507.

In step 507, the video transmission is started. The procedure then proceeds to a step 509. In step 509 an RTCP loop is started. In the RTCP loop the AMR frame since the start of the speech transmission is obtained in a step 511. Then the AMR frame number at the RTP TS transmitted in the RTCP SR is determined in a step 513. Then based on the information resulting from the RTCP loop is used to construct a RTCP SR and APP message in a step 515.

Next, in a step 517 the RTCP SR and APP message is transmitted. The steps 509-517 are then repeated at a suitable time interval as indicated in step 519. When the session ends the procedure proceeds to step 521.

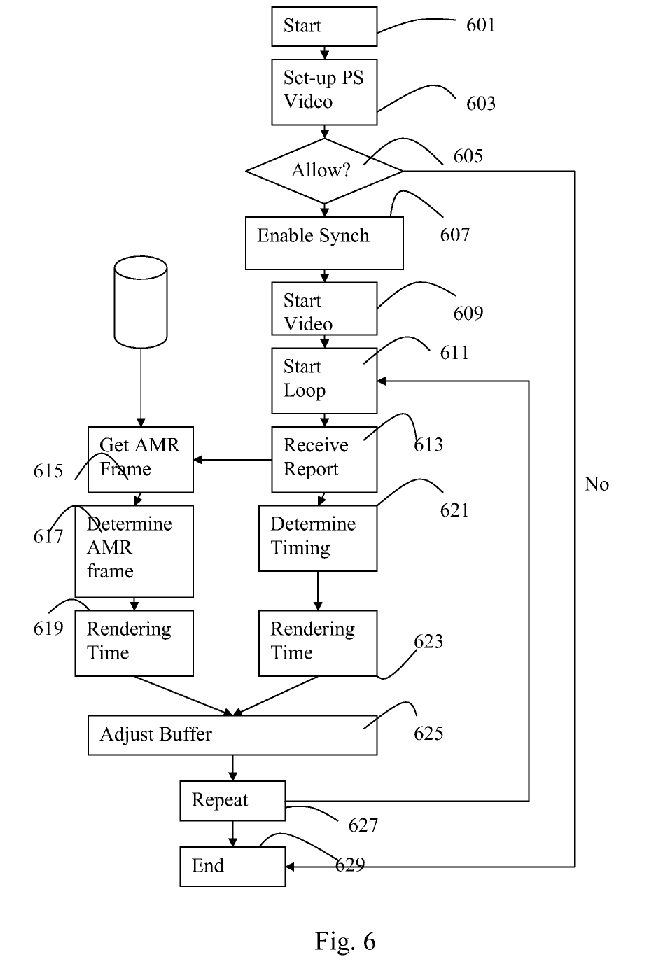

In FIG. 6 an exemplary flow chart of procedural steps performed in a receiver when receiving synchronized CS speech with PS video using out of band synchronization is shown. First the reception is initiated in a step 601. Next in a step 603 an invitation for a PS session is received. Thereupon in a step 605 the receiver decides if the Video session is to be allowed. If the video session is rejected the procedure ends in a step 629. If the video session is accepted the procedure continues to a step 607. In step 607 enabling of synchronization with CS speech is initiated. Next the receiver starts to receive video in a step 609. Thereupon a RTCP receiving loop is initiated in a step 611. In the receiving loop the receiver receives a RTCP SR and APP report in a step 613. The receiver also obtains the AMR speech frame number since the beginning of the session in a step 615. Also the absolute timing of the AMR speech frames are determined in a step 617 and the rendering time mapping of a speech frame number is determined in a step 619. Also the absolute timing of video frames is determined in a step 621 and the rendering time mapping of a video frame with a RTP TS number is determined. Next in a step 623 the rendering time for the speech frame and the video frame with a RTP TS number is determined and the buffering is adjusted accordingly. The RTCP receiving loop is then repeated as indicated by step 627 until the session ends in a step 629.

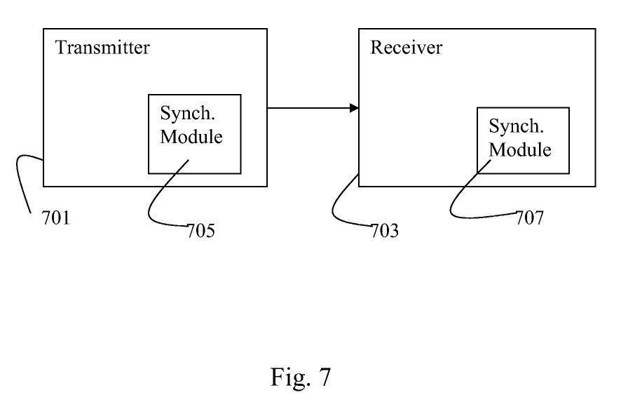

In FIG. 7 a communication system, in particular a HSPA communication system comprising a transmitter 701 and a receiver 703 is depicted. The transmitter 701 comprises a synchronization module 705 adapted to generating a rendering and capturing clock for a circuit switched speech connection and for a packet switched video connection. The synchronization module 705 can preferably be adapted to generate a rendering and capturing clock for a circuit switched speech connection and for a packet switched video connection in accordance with any of the synchronization methods described hereinabove. The receiver 703 further comprises a synchronization module 707 adapted to provide synchronization between data received on a circuit switched speech connection and a packet switched video connection. The synchronization module 707 can preferably be adapted to provide synchronization in accordance with any of the synchronization methods described hereinabove.

Using the method and system as described herein will allow a transmitter to generate a PS video data stream that can be synchronized with a parallel CS speech data stream by a receiver thereby enabling synchronization of CS speech with PS video. This will significantly enhance the media quality of a video session.

1-21. (canceled)

22. A method of transmitting a speech data stream and a video data stream, from a transmitter to a receiver to be synchronized by the receiver, wherein the video data is transmitted over a packed switched connection, said method comprising:
transmitting the speech data over a circuit switched connection;
generating in the transmitter a rendering and capturing clock for the circuit switched connection and for the packet switched connection;
transmitting the rendering and capturing clock for the circuit switched connection and for the packet switched connection to the receiver; and
synchronizing in the receiver the circuit switched connection and packet switched connection in the receiver using the rendering and capturing clock for the circuit switched connection and for the packet switched connection received from the transmitter.

23. The method according to claim 22, wherein the speech data is transmitted using a High Speed Packet Access (HSPA) connection.

24. The method according to claim 22, wherein sender wall clock information is transmitted to the receiver.

25. The method according to claim 24, wherein the sender wall clock information is transmitted using in-band signaling.

26. The method according to claim 25, wherein the in-band clock information is transmitted using Dual Tone Multi Frequency (DTMF) tones.

27. The method according to claim 24, wherein the sender wall clock information is transmitted using out of band signaling.

28. The method according to claim 22, wherein the packet switched data is transmitted using Real Time Protocol (RTP).

29. A transmitter for transmitting a speech data stream and a video data stream to a receiver to be synchronized by the receiver, wherein the video data is transmitted over a packed switched connection, said transmitter comprising a synchronization module configured to:
transmit the speech data over a circuit switched connection;
generate in the transmitter a rendering and capturing clock for the circuit switched connection and for the packet switched connection; and
transmit the rendering and capturing clock for the circuit switched connection and for the packet switched connection to the receiver.

30. The transmitter according to claim 29, wherein the transmitter is configured to transmit the speech data using a High Speed Packet Access (HSPA) connection.

31. The transmitter according to claim 29, wherein the transmitter is configured to transmit sender wall clock information to the receiver.

32. The transmitter according to claim 31, wherein the transmitter is configured to transmit the sender wall clock information using in-band signaling.

33. The transmitter according to claim 32, wherein the transmitter is configured to transmit in-band clock information using Dual Tone Multi Frequency (DTMF) tones.

34. The transmitter according to claim 31, wherein the transmitter is configured to transmit the sender wall clock information using out of band signaling.

35. The transmitter according to claim 29, wherein the transmitter transmits the packet switched data using Real Time Protocol (RTP).

36. A receiver for receiving a speech data stream and a video data stream from a transmitter to be synchronized by the receiver, wherein the video data is received over a packed switched connection, said receiver comprising a synchronization module configured to:
receive a rendering and capturing clock for the circuit switched connection and for the packet switched connection; and
synchronize the circuit switched connection and packet switched connection using the received rendering and capturing clock for the circuit switched connection and for the packet switched connection.

37. The receiver according to claim 36, wherein the receiver is configured to receive the speech data over a High Speed Packet Access (HSPA) connection.

38. The receiver according to claim 36, wherein the receiver is configured to receive sender wall clock information from the transmitter.

39. The receiver according to claim 38, wherein the receiver is configured to receive the sender wall clock information via in-band signaling.

40. The receiver according to claim 39, wherein the receiver is configured to receive in-band clock information via Dual Tone Multi Frequency (DTMF) tones.

41. The receiver according to claim 38, wherein the receiver is configured to receive the sender wall clock information via out of band signaling.

42. The receiver according to claim 36, wherein the receiver is configured to receive the packet switched data over a Real Time Protocol, RTP connection.
